(19) United States
(12) Patent Application Publication
(10) Pub. No.: US 2010/0038189 A1
(43) Pub. Date: Feb. 18, 2010

(54) Arresting Brake For Arresting At Least One Rotatably Mounted Component With Respect To A Housing

(76) Inventors: Nicolai Tarasinski, Frankenthal (DE); Matthias Lang, Mannheim (DE); Rainer Gugel, Mannheim (DE); Bernd Kneer, Viernheim (DE)

Correspondence Address: DEERE & COMPANY, ONE JOHN DEERE PLACE, MOLINE, IL, 61265, US

(21) Appl. No.: 12/444,812

(22) PCT Filed: Sep. 20, 2007
(86) PCT No.: PCT/EP07/59987

§ 371 Date: Apr. 8, 2009

(30) Foreign Application Priority Data
Oct. 13, 2006 (DE) 10 2006 048 558.0

(51) Int. Cl. B60L 7/24; B60L 7/00

(52) U.S. Cl. 188/31; 188/161

(57) ABSTRACT

The present invention relates to an arresting brake (10) for arresting at least one rotatably mounted component (12, 14) with respect to a housing (32), and is suitable in particular for use in an agricultural or industrial utility vehicle. The arresting brake (10) comprises an electromagnet (26), two armature components (40, 42) and two rotatably mounted components (12, 14). The electromagnet (26) preferably has a core (26) and a coil (30; 50, 52). The armature components (40, 42) are arranged such that they can move in relation to the electromagnet (26) and are rotationally fixed with respect to the housing (32). The electromagnet (26) is arranged between the armature components (40, 42), in order to arrest the rotatably mounted components (12, 14) using the arresting brake (10), in each case an armature component (40, 42) can be engaged with, in each case, one rotatably mounted component (12, 14). The armature components (40, 42) are prestressed in such a way that in the deactivated state of the electromagnet (26) the armature components (40, 42) are each in engagement with the rotatably mounted components (12, 14), and that in the activated state of the electromagnet (26) the armature components (40, 42) are not in engagement with the rotatably mounted components (12, 14).

The invention relates to an arresting brake for arresting at least one rotatably mounted component with respect to a housing.

Arresting brakes are used in agricultural or industrial utility vehicles, for example in the form of a parking brake. Parking brakes are components of a vehicle which are critical for safety. The parking brake is used to prevent the vehicle from rolling away even when it is in the switched-off and therefore nonenergized state. A parking brake is usually applied with spring loading, that is to say a prestressing force is provided which always forces the activation mechanism into an engaged position of the parking brake (that is to say in particular in the nonenergized state of the vehicle) when an actuator moves the activation mechanism into a disengaged position, counter to the prestressing force. In tractors by the applicant, a parking brake arm which is mounted on one side in the transmission housing is used. This arm can carry out a pivoting movement through several degrees and as a result lock a gearwheel, fixed to a shaft, on the output shaft in the transmission. The pivoting movement can be locked by means of a rotatable link. The link is supported on the transmission housing via a housing lid. The parking brake can basically be purely mechanical, that is to say can be activated hydraulically or electromagnetically by means of a corresponding linkage.

Electromagnetically activated positively locking and non-positively locking arresting brakes are known as switching elements in industry and are widespread. Vehicles with electromagnet brakes as service brakes and/or holding brakes are also known. If such vehicles were embodied with an individual wheel drive, a separate arresting brake with, in each case, an actuator which can be activated electromechanically would have to be provided on each wheel. Such a solution would be complicated and expensive since twice the number of components would have to be provided. Furthermore, such a design would, under certain circumstances, require installation space which could not be provided.

The present invention is therefore based on the object of specifying and developing an arresting brake of the type mentioned at the beginning which permits the abovementioned problems to be overcome. In particular, a simplified design, which preferably takes up less installation space, is to be made available.

The object is achieved according to the invention by means of the teaching of patent claim 1. Further advantageous refinements and developments of the invention emerge from the subclaims.

The arresting brake according to the invention for arresting at least one rotatably mounted component with respect to a housing is suitable in particular for use in an agricultural or industrial utility vehicle. The arresting brake comprises an electromagnet, two armature components and two rotatably mounted components. The electromagnet preferably has a core and a coil. The armature components are arranged such that they can move in relation to the electromagnet and are rotationally fixed with respect to the housing. The electromagnet is arranged between the armature components. In order to arrest the rotatably mounted components using the arresting brake, in each case an armature component can be engaged with in each case one rotatably mounted component. The armature components are prestressed in such a way that in the deactivated state of the electromagnet the armature components are respectively in engagement with the rotatably mounted components and that in the activated state of the electromagnet the armature components are not in engagement with the rotatably mounted components.

Firstly, the invention has recognized that the abovementioned problems can be solved if merely one electromagnet unit or an electromagnet is provided. The electromagnet unit is arranged between the two armature components and can, as it were, activate one armature component and the other armature component. In other words, the arresting brake according to the invention is arranged in an area in which it can be engaged with the two rotatably mounted components, for example in a central area or in an area between the two rotatably mounted components. The electromagnet could be arranged centrally or coaxially between the armature components with respect to the longitudinal axes of the rotatably mounted components with the result that, for example, a rotationally symmetrical arrangement of the electromagnet with respect to at least one longitudinal axis of a rotatably mounted component is produced. An arresting brake according to the invention is quite particularly suitable as a parking brake for individual wheel drives, wherein in each case one wheel is driven by in each case one rotatably mounted component. Accordingly, the rotatably mounted components can rotate independently of one another.

The electromagnet is preferably arranged in a positionally fixed fashion on the housing. As a result, for example, the supply of electricity to the electromagnet can be implemented easily and without slip rings.

In one preferred embodiment, an armature component is formed essentially in a plate shape, at least in certain areas. Of course, it would also be possible to provide that the two armature components are embodied essentially in a plate shape at least in certain areas and/or are embodied and arranged mirror-inverted with respect to the electromagnet.

One armature component could be embodied essentially in a plate shape in particular in an area which faces the electromagnet. After the electromagnet has been activated, the electromagnet would, for example, attract the armature components, specifically until they bear against the electromagnet or the core or rest on it in a planar fashion if the electromagnet is embodied in a planar fashion in an area facing the armature plates.

It is particularly advantageous if the electromagnet and the plate-shaped area of the armature component are arranged in such a way that the force of the electromagnet acts essentially perpendicularly with respect to the plate-shaped area of the armature component. This permits optimum transmission of force to be achieved.

The armature component expediently has material which is attracted by the magnetic field of the electromagnet. For example, the armature component is fabricated from metal, in particular iron or steel. The armature component is therefore attracted by the electromagnet if a current flows through the coil of the electromagnet and as a result a magnetic field is built up.

According to one preferred embodiment, at least one guide means, with which an armature component can be guided between the engaged or arrested position and the nonengaged or released position, is provided. The guide means is arranged on the housing in a locationally fixed fashion, for example in the form of at least one rod. In this case, the armature component could have a recess for each rod, said recess engaging around the rod in the mounted state. The guide means could be embodied in such a way that the armature component is guided on an essentially linear movement by means of the at least one guide means. This is the case, for example, if the guide means is embodied in the form of a rod.

A rotatably mounted component will usually have a shaft, wherein the shaft is rotatably connected to an individual wheel drive of the utility vehicle via an intermediate gear mechanism or a reduction stage. For the rotatably mounted component, usually at least one bearing, with which the component is mounted for its rotation in a housing, is provided. In the operating state in which the arresting brake is not engaged, such a shaft is driven by an engine of the vehicle, as a result of which the vehicle can be propelled.

According to one preferred embodiment, a corresponding plate or corresponding disk is provided on a rotatably mounted component. The corresponding plate is connected in a rotationally fixed fashion to the rotatably mounted component. The corresponding plate can be engaged with an armature component. The corresponding plate could be a type of coupling plate or a disk with a tooth system, wherein a friction face of the coupling plate can be engaged with an armature component with the result that a rotationally fixed (frictionally locking or non-positively locking) connection can be produced between the corresponding plate and the armature component if the two parts are in engagement with one another. If the corresponding plate is embodied in a disk shape with a tooth system, the armature component has a tooth system which is embodied in an essentially complementary fashion thereto. If the disk is in engagement with the corresponding plate, this produces a positively locking, rotationally fixed connection between the two components. The corresponding plate could have an internal tooth system which, for the purposes of forming a rotationally fixed connection to the rotatably mounted component, engages in an external thread of the rotatably mounted component.

The corresponding plate is preferably arranged at a free end of the rotatably mounted component. However, it would also be possible to provide that the rotationally mounted component extends spatially at least partially into the electromagnet. In this case, the corresponding plate would be arranged in an area near to the end of the rotatably mounted component which faces the electromagnet.

As already indicated, the armature component and/or the corresponding plate could have at least one friction element or a friction coating for producing a frictionally locking or non-positively locking connection between the armature component and the corresponding plate. Such a friction element would be provided on the side respectively facing the other component.

Alternatively or additionally to this, the armature component and/or the corresponding plate could have at least one tooth system for producing a positively locking connection between the armature component and the corresponding plate. Such a tooth system would also have to be provided on the side respectively facing the other component.

In a quite particularly preferred embodiment, the armature components are prestressed with at least one spring element. Such a spring element could, in the simplest case, have a correspondingly dimensioned disk spring or helical spring. A hydraulically prestressed and/or pneumatically prestressed cylinder, which is correspondingly arranged between the two armature components, could also be provided as a spring element. The spring element should at any rate be prestressed with a suitable force in such a way that in the deactivated operating state of the electromagnet the armature component is in engagement with the rotatably mounted component or the corresponding plate which is arranged adjacent to said armature component, and effectively a positively locking or non-positively locking, rotationally fixed connection is maintained between the two components. As a result, it is possible, for example, to implement a parking brake for, in each case, two individually driven wheels.

In one preferred embodiment, at least part of the housing is embodied and arranged relative to the electromagnet in such a way that this part acts as a magnetic return. In this case, the coil of the electromagnet could extend as far as the housing wall with the result that the magnetic field lines, running outside the coil, of the electromagnet run through the housing or penetrate the housing at least in certain areas.

The electromagnet could preferably have a pot magnet. The central axis thereof could essentially coincide with a longitudinal axis of a rotatably mounted component with the result that virtually a rotationally symmetrical design of the electromagnet and armature component is produced. The pot magnet could have, in its outer area, a magnetizable material, for example steel or iron, which surrounds the coil. This material or this area of the housing of the pot magnet could be embodied in such a way that one armature component or both armature components comes/come to bear against it if the armature components are not in engagement with the rotatably mounted component in the activated state of the electromagnet. A magnetizable material, against which the armature components also come to bear in the activated state of the electromagnet, could also be provided in an inner area of the pot magnet.

In a quite particularly preferred embodiment, the arresting brake or the electromagnet according to the invention is actuated with the aid of a control device or with a method for actuating a transmission shifting point as claimed in one of the claims of DE 10 2005 039 263, which was not yet published on the application date of this patent application. Reference is made below to DE 10 2005 039 263 with respect to the control device and respectively to the method for actuating the transmission shifting point. For this reason the entire disclosure content of this patent application are included here by reference.

If the armature component is to be placed in a state in which it is to be moved counter to the prestressing force and is therefore not in engagement with the rotatably mounted component, an electric current with a predefinable first current value is applied to the coil of the electromagnet. This first current value is dimensioned in such a way that the force acting on the armature component from the magnetic field of the electromagnet is of such a magnitude that at any rate the movement of the armature component can be executed counter to the prestressing force.

In order to keep the armature component in the state in which it could be moved counter to the prestressing force and in which the armature component bears, for example, against the core of the electromagnet, an electric current of a predefinable, second current value is applied to the coil of the electromagnet, wherein the second current value is lower than the first current value. The armature component is attracted by the magnetic field of the electromagnet. Since the armature component is arranged closer to the electromagnet in this state, it is also sufficient, with the electric current of the second current value, to keep the armature component in this position against the coil of the electromagnet, since when the armature component is at a small distance from the electromagnet (i.e. reduced air gap or air gap of a negligible width) the magnetic field is nevertheless large enough (because of a reciprocal dependence of the magnetic field strength on the location coordinate as a function of the distance from the electromagnet) even if the holding current which is necessary for this is only a fraction—for example ⅕ to ⅙—of the electric current of the first current value, said fraction being set to move the armature component. Accordingly, an electric current of the first predefinable current value or of the second predefinable current value could be applied to the coil in the sense of DE 10 2005 039 263. It is also conceivable to equip the electromagnets with two coils which can be actuated separately. In such a case, electric current of the first predefinable current value could be applied to a coil of the electromagnet, and electric current of the second predefinable value could be applied to a second coil in the sense of DE 10 2005 039 263.

In order to move the armature component into a position in which it is spaced apart from the electromagnet, the electric current is not applied to the coil of the electromagnet. The armature component is therefore quite simply moved into the spaced-apart position, in which it is engaged with the rotatably mounted component by virtue of the prestressing force by simply interrupting the flow of current through the electromagnet. This is ultimately also appropriate for safety-related reasons because when there is a current failure, the arresting brake according to the invention is then automatically in the locked state or in its engaged position.

Although the entire disclosure contents of DE 10 2005 039 263 is included here by reference, it is to be particularly noted that the current which is applied to the electromagnet can be pulsed, and is in particular pulse-width-modulated. As a result, in a quite particularly advantageous way, the energy requirement for holding the armature component in the position in which the prestressing force has to be overcome is very low.

In order to detect the rotational speed of the rotatably mounted component, the corresponding plate which is assigned to this rotatably mounted component could have a tooth system. The rotational speed could be detected, for example, by means of a Hall sensor if the tooth system is embodied in a magnetized fashion.

In a quite particularly preferred embodiment, the individually driven wheels of an axle of the vehicle can be arrested with an arresting brake as claimed in one of claims 1 to 14. To this extent, it is therefore possible to implement an individual wheel drive of a vehicle in which the individually driven wheels can be arrested with just one assembly (specifically the arresting brake according to the invention). The vehicle is quite particularly preferably an agricultural of industrial utility vehicle, and in particular a tractor.

As a result, an agricultural or industrial utility vehicle, in particular a tractor, can be made available which has at least one individual wheel drive for two individually driven wheels, wherein the driven wheels of one axle of the vehicle can be arrested with an arresting brake as claimed in one of claims 1 to 14. In order to avoid repetitions, reference is made to the preceding part of the description with respect to the structural embodiment of the arresting brake.

There are then various possible ways of advantageously configuring and developing the teaching of the present invention. In this respect, reference is made, on the one hand, to the patent claims which are dependent on patent claim 1 and, on the other hand, to the following explanation of the preferred exemplary embodiments of the invention with reference to the drawing. In conjunction with the explanation of the preferred exemplary embodiment of the invention, generally preferred refinements and developments of the teaching will also be explained with reference to the drawing. In the drawing, in each case in a schematic illustration,

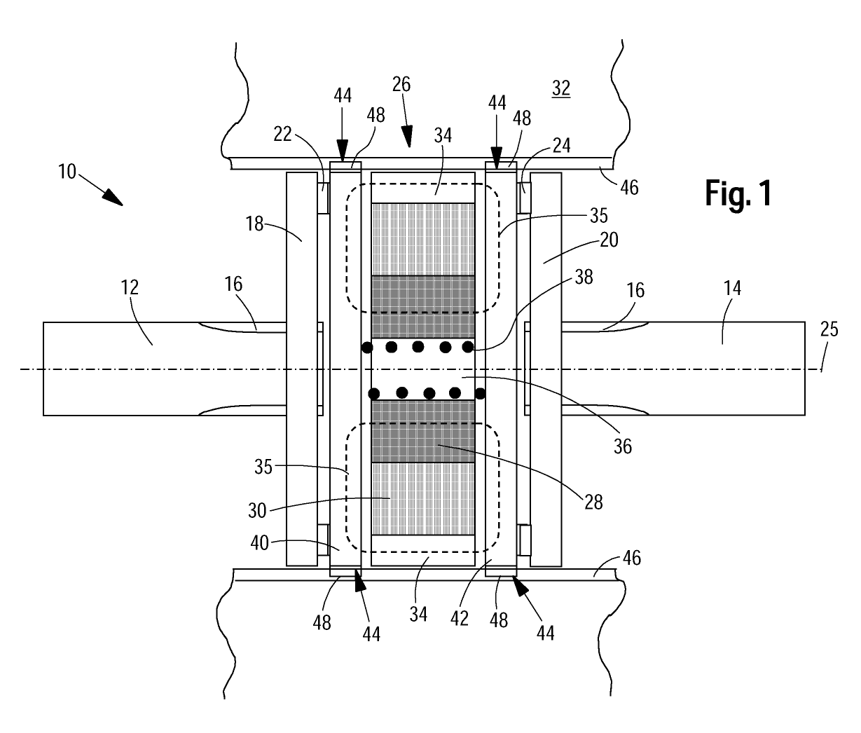

FIG. 1 is a sectional view of a first exemplary embodiment of an arresting brake according to the invention,

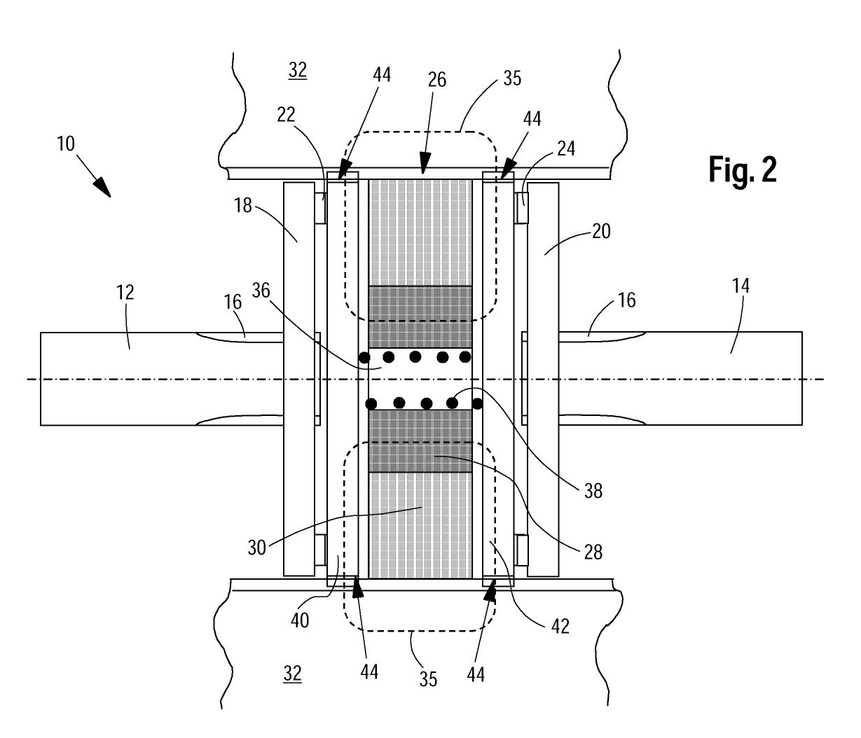

FIG. 2 is a sectional view of a second exemplary embodiment of an arresting brake according to the invention, and

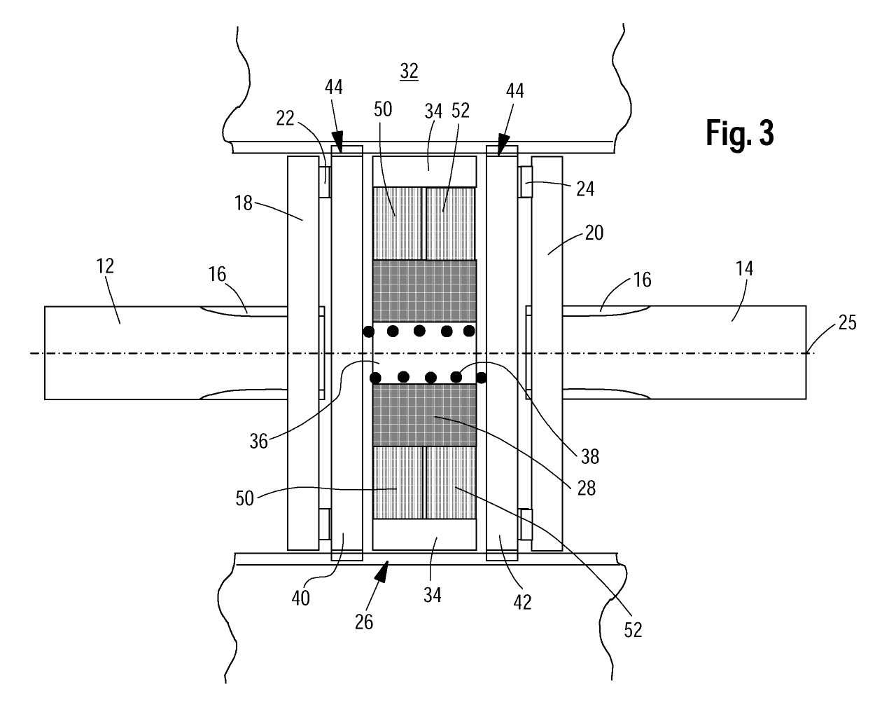

FIG. 3 is a sectional view of a third exemplary embodiment of an arresting brake according to the invention.

Identical or similar components are characterized by the same reference symbols in the figures.

FIG. 1 shows an arresting brake 10 according to the invention, with which two rotatably mounted components 12, 14 can be arrested. By means of the rotatably mounted components 12, 14, wheels (not shown in the figures) can be respectively rotatably connected, wherein the left-hand wheel of a vehicle axle can be driven with the rotatably mounted component 12 shown on the left, and the right-hand wheel of a vehicle axle can be driven with the rotatably mounted component 14 shown on the right. The left-hand and right-hand wheels can be driven independently of one another. In other words, the drive is an individual wheel drive. Both the left-hand and right-hand rotatably mounted components 12, 14 have an external tooth system 16 with which the rotatably mounted component 12, 14 can be respectively connected in a rotationally fixed fashion to a corresponding plate 18, 20. Accordingly, the corresponding plates 18, 20 each have an internal tooth system which is embodied so as to be complementary to the external tooth system 16. The corresponding plates 18, 20 are therefore provided at the free ends of the rotatably mounted component 12, 14. In an outer area of each of the counter plates 18, 20 a tooth system 22, 24 is provided, which tooth systems 22, 24 are provided on the circumference on the side facing the other corresponding plate and which are embodied in the axial direction. The components 12, 14 are mounted in bearings so as to be rotatable around the axle 25, the bearings not being shown in the figures.

An electromagnet 26 is provided which has a core 28 and a coil 30. The electromagnet 26 is arranged in a rotationally fixed fashion in the housing 32 in which the arresting brake 10 is arranged. The electromagnet according to FIG. 1 is a pot magnet, wherein the coil 30 is wound with its winding around the core 28. The core is embodied from a magnetizable material, specifically from iron or steel. In an outer area 34 of the electromagnet 26, a magnetizable material is also provided. To this extent, the magnetic field lines run both through the core 28 and through the magnetic return 34 of the electromagnet 26. Overall, a magnetic field is formed whose field lines are formed or run in a toroidal shape around the coil 30. In FIG. 1, field lines 34 are indicated by dashes, which would also occur when an electromagnet 26 is activated.

The core 28 has a bore 36 in which a spring 38 is arranged. The spring 38 is prestressed and respectively forces the armature components 40, 42 in the direction of the counter plates 18, 20. In other words, the spring 38 forces the armature components 40, 42 away from the electromagnet 26. The electromagnet 26 is arranged between the armature components 40, 42. The armature components 40, 42 are embodied essentially in a plate shape, and composed of magnetizable material and are correspondingly attracted by the electromagnet 26 if the latter is activated and a magnetic field is built up.

The armature components 40, 42 are arranged so as to be movable relative to the electromagnet 26 and the housing 32 in the direction of the axle 25. The armature components 40, 42 can therefore be engaged with each of the corresponding plates 18, 20 in a possible operating position with the result that ultimately the respectively rotatably mounted component 12, 14 can be arrested with respect to the housing 32 by means of the respective corresponding plate 18, 20. In such an operating state, which is shown in FIG. 1, the arresting brake is engaged and the rotatably mounted components 12, 14 are arrested. In this operating state, the armature components 40, 42 are forced with their tooth system 22, 24 into the corresponding tooth systems of the corresponding plate 18, 20 by the prestressed spring 38.

If the electromagnet 26 is activated, the armature components 40, 42 are attracted by the electromagnet with the result that the tooth systems 22, 24 do not engage one in the other and the corresponding plates 18, 20 and the rotatably mounted components 12, 14 which are respectively connected thereto are released with the result that in this operating state of the arresting brake 10 the rotatably mounted components 12, 14 are not arrested. Between these two operating states, the armature components 40, 42 each execute an essentially linear movement, which is guided by correspondingly provided guide means 44. The guide means 44 has a tooth system 46 which is provided on the housing 32 or a correspondingly embodied projection and a tooth system 48, embodied in an essentially complementary fashion thereto, of the armature components 40, 42. To this extent, an armature component 40, 42 is arranged in a rotationally fixed fashion in the housing 32 and is guided by the guide means 44 with respect to a linear movement along the axle 24 inside the housing 32.

FIG. 2 shows, in a schematic illustration, a further exemplary embodiment of an arresting brake 10 according to the invention, which is embodied in a similar way to the exemplary embodiment according to FIG. 1. The electromagnet 26 also has a core 28 and a coil 30. However, in the exemplary embodiment according to FIG. 2 the electromagnet 26 does not comprise a component which corresponds to the magnetic return 34 from FIG. 1. Correspondingly, the armature components 40, 42 come to bear only against the core 28 of the electromagnet 26, with the radially outer areas of the armature components 40, 42 also being able to come to bear against the coil 30. As a result, when an electromagnet 26 is activated, toroidal field lines 35 are also formed and they extend through the housing 32 in the outer area of the electromagnet 26. In the exemplary embodiment according to FIG. 1, in the activated state of the electromagnet, an armature component 40, 42 accordingly comes to bear against the core 28 and against the magnetic return 34.

FIG. 3 shows a third exemplary embodiment of an arresting brake according to the invention in a schematic illustration. This exemplary embodiment is also embodied in an essentially comparable way to the exemplary embodiments in FIGS. 1 and 2. The electromagnet 26 according to FIG. 3 has two coils 50, 52 which are would around the core 28 of the electromagnet 26. Current can be applied to the coils 50, 52 separately. Said coils 50, 52 can be embodied and actuated in such a way that as a result of this redundancy is provided when the electromagnet 26 is activated and therefore when the arresting brake is released. If, in fact, for example the circuit which supplies the coil 50 with current or the circuit which supplies the coil 52 with current (not shown in the figures) were to fail, the magnetic field of the electromagnet 26, which is in this case then only built up with the aid of the coil 50, is still strong enough to cause the armature components 40, 42 to bear against the electromagnet 26 so that the arresting brake 10 is released. Other actuation strategies are also conceivable, specifically, for example, that the armature components 40, 42 can be made to bear against the electromagnet 26 only if current is applied simultaneously to both coils.

In conclusion it is to be particularly noted that the exemplary embodiments explained above serve merely to describe the claimed teaching but do not restrict said teaching to the exemplary embodiments.

1. An arresting brake for arresting at least one rotatably mounted component (12, 14) with respect to a housing (32), in particular for use in an agricultural or industrial utility vehicle, having an electromagnet (26), two armature components (40, 42) and two rotatably mounted components (12, 14), wherein the electromagnet (26) preferably has a core (28) and a coil (30; 50, 52), wherein the armature components (40, 42) are arranged such that they can move in relation to the electromagnet (26) and are rotationally fixed with respect to the housing (32), wherein the electromagnet (26) is arranged between the armature components (40, 42), wherein, in order to arrest the rotatably mounted components (12, 14) using the arresting brake (10), in each case an armature component (40, 42) can be engaged with, in each case, one rotatably mounted component (12, 14), wherein the armature components (40, 42) are prestressed in such a way that in the deactivated state of the electromagnet (26) the armature components (40, 42) can each be in engagement with the rotatably mounted components (12, 14), and in that in the activated state of the electromagnet (26) the armature components (40, 42) cannot be in engagement with the rotatably mounted components (12, 14).

2. The arresting brake as claimed in claim 1, characterized in that the electromagnet (26) is arranged in a positionally fixed fashion on the housing (32).

3. The arresting brake as claimed in claim 1 or 2, characterized in that an armature component (40, 42) is formed essentially in a plate shape at least in certain areas, in particular in an area which faces the electromagnet (26), and wherein the electromagnet (26) and the plate-shaped area of the armature component (40, 42) are preferably arranged in such a way that the force of the electromagnet (26) acts essentially perpendicularly with respect to the plate-shaped area of the armature component (40, 42).

4. The arresting brake as claimed in one of claims 1 to 3, characterized in that the armature component (40, 42) has material which is attracted by the magnetic field of the electromagnet (26), said material being, for example, metal, in particular iron or steel.

5. The arresting brake as claimed in one of claims 1 to 4, characterized in that at least one guide means (44) is provided, with which guide means (44) an armature component (40, 42) can be guided between the engaged position and the nonengaged position, and wherein the armature component (40, 42) is guided on an essentially linear movement by means of the at least one guide means (44).

6. The arresting brake as claimed in one of claims 1 to 5, characterized in that a rotatably mounted component (12, 14) has a shaft which is preferably rotatably connected to an individual wheel drive of the utility vehicle.

7. The arresting brake as claimed in one of claims 1 to 6, characterized in that a corresponding plate (18, 20), which is connected in a rotationally fixed fashion to the rotatably mounted component (12, 14) and which can be engaged with an armature component (40, 42), is provided on a rotatably mounted component (12, 14), and wherein the corresponding plate (18, 20) is preferably arranged at a free end of the rotatably mounted component (12, 14).

8. The arresting brake as claimed in one of claims 1 to 7, characterized in that the armature component (40, 42) and/or the corresponding plate (18, 20) has at least one friction element for producing a frictionally locking or non-positively locking connection between the armature component (40, 42) and corresponding plate (18, 20).

9. The arresting brake as claimed in one of claims 1 to 8, characterized in that the armature component (40, 42) and/or the corresponding plate (18) has at least one tooth system (22, 24) for producing a positively locking connection between the armature component (40, 42) and corresponding plate (18, 20).

10. The arresting brake as claimed in one of claims 1 to 9, characterized in that the armature components (40, 42) are prestressed using at least one spring element (38).

11. The arresting brake as claimed in one of claims 1 to 10, characterized in that at least part of the housing (32) is embodied and arranged relative to the electromagnet (26) in such a way that this part acts as a magnetic return.

12. The arresting brake as claimed in one of claims 1 to 11, characterized in that the electromagnet (26) has a pot magnet.

13. The arresting brake as claimed in one of claims 1 to 12, characterized in that the electromagnet (26) can be actuated as claimed in one of the claims in DE 10 2005 039 263.

14. The arresting brake as claimed in one of claims 1 to 13, characterized in that a corresponding plate (18, 20) has a tooth system with which the rotational movement of the corresponding plate (18, 20), and therefore of the rotatably mounted component (12, 14), can be detected, preferably by means of a Hall sensor.

15. An individual wheel drive of an agricultural or industrial utility vehicle, in particular of a tractor, characterized in that the driven wheels of an axle of the vehicle can be arrested using an arresting brake (10) as claimed in one of claims 1 to 14.

16. An agricultural or industrial utility vehicle, in particular a tractor, which has at least one individual wheel drive for two individually driven wheels, characterized in that the driven wheels of an axle of the vehicle can be arrested using an arresting brake (10) as claimed in one of claims 1 to 14.
